(19) United States
(12) Patent Application Publication
(10) Pub. No.: US 2026/0030366 A1
(43) Pub. Date: Jan. 29, 2026

(54) METHODS, SYSTEMS, APPARATUSES, AND COMPUTER-READABLE MEDIA FOR DETECTING VULNERABILITIES IN COMPUTER CODE

(71) Applicant: HUAWEI TECHNOLOGIES CO., LTD., Shenzhen (CN)

(72) Inventors: Jiayuan Zhou, Kanata (CA); Xing Hu, Kanata (CA); Kui Liu, Kanata (CA); Xin Xia, Kanata (CA); Xiangfu Song, Kanata (CA)

(21) Appl. No.: 19/351,039

(22) Filed: Oct. 6, 2025

Related U.S. Application Data
(63) Continuation of application No. PCT/CN2023/109824, filed on Jul. 28, 2023.

(51) Int. Cl. G06F 21/57; G06F 8/70

(52) U.S. Cl. CPC G06F 21/577; G06F 8/70; G06F 2221/033

(57) ABSTRACT

A method, system, apparatus, and computer-readable storage medium for detecting vulnerabilities in computer code. A computer processor calculates a function change log of a section of the computer code, the function change log comprising at least one intermediate change between a first version of the section of computer code and a second version of the section of computer code, the section of the computer code being similar to a computer-code vulnerability, and the first version is a version prior to the second version. The computer processor determines whether the section of the computer code comprises the computer-code vulnerability based on a similarity between the function change log and a fix change log, the fix change log comprising at least one code change for fixing the computer-code vulnerability.

### CROSS-REFERENCE TO RELATED APPLICATION

This application is a continuation of PCT International Patent Application Serial No. PCT/CN2023/109824 filed on Jul. 28, 2023, the content of which is incorporated herein by reference in its entirety.

### TECHNICAL FIELD

The present disclosure relates generally to methods, systems, apparatuses, and computer-readable storage media for detecting vulnerabilities in computer code, and in particular to methods, systems, apparatuses, and computer-readable storage media for reducing the number of false positives when detecting vulnerabilities in computer code.

### BACKGROUND

In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be fixed.

### SUMMARY

Generally according to some embodiments of the disclosure, there are described methods for detecting vulnerabilities in computer code. In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be patched or fixed. Clone-based approaches consider the recurring vulnerability detection problem as a code clone detection problem, such as token- or syntax-based detection. Clone-based approaches may search for computer code sections (also referred to as snippets) in target computer code repositories that are similar to known vulnerabilities. The problem with these clone-based approaches is that they have a high false positive rate. Patches or fixes of vulnerabilities often make small changes to the computer code. As a result, a computer code section containing a vulnerability may be similar to a patched computer code section that does not contain the vulnerability. The differences between a vulnerable code section and a patched code section may be minimal and not detectable by a clone-based approach. Clone-based approaches may detect the patched computer code section as a vulnerability resulting in a false positive.

In some embodiments of the disclosure, a method for detecting vulnerabilities in computer code comprises the following steps. The method may detect a section of computer code in a target computer code repository that is similar to a known vulnerability using any of the traditional methods, such as clone-based and learning-based methods. The method may calculate a function change log for the section of computer code, which is a line-level record of the at least some of the historical changes to the section of computer code. The method may compare the function change log to a fix change log for the known vulnerability. The fix change log is the line-level code changes required to fix the known vulnerability. If the function change log is similar to the fix change log, the method may determine that the patch has been applied to the section of computer code. The section of computer code may be a potential false positive and may not contain the vulnerability. If the function change log is not similar to the fix change log, the method may determine that the patch has not been applied to the section of computer code. The section of computer code may not be a potential false positive and may contain the vulnerability. Determining whether the function change log is similar to the fix change log may comprise determining whether the fix change log is a subsequence of the function change log.

According to a first aspect of the disclosure, there is described a method for detecting vulnerabilities in computer code. The method comprises calculating a function change log of a section of the computer code, the function change log comprising at least one intermediate change between a first version of the section of computer code and a second version of the section of computer code, the section of the computer code being similar to a computer-code vulnerability, and the first version is a version prior to the second version. The method further comprises determining whether the section of the computer code comprises the computer-code vulnerability based on a similarity between the function change log and a fix change log, the fix change log comprising at least one code change for fixing the computer-code vulnerability.

The method may further comprise calculating the fix change log.

The method may further comprise locating the section of the computer code that is similar to the computer-code vulnerability.

Locating the section of the computer code that is similar to the computer-code vulnerability may comprise using code clone detection. Locating the section of the computer code that is similar to the computer-code vulnerability may comprise using artificial intelligence.

The method may further comprise determining the similarity of the function change log and the fix change log using a matching method. The matching method may comprise determining whether the fix change log is a subsequence of the function change log. The matching method may use artificial intelligence to determine the similarity of the function change log and the fix change log.

Determining whether the section of the computer code comprises the computer-code vulnerability may comprise determining that the section of the computer code does not comprise the computer-code vulnerability when the function change log is similar to the fix change log.

Determining whether the section of the computer code comprises the computer-code vulnerability may comprise determining that the section of the computer code comprises the computer-code vulnerability when the function change log is not similar to the fix change log.

The method may further comprise receiving the computer-code vulnerability from a security advisory service. The method may further comprise receiving the computer-code vulnerability and the fix change log from a vulnerability database.

The method may further comprise displaying the section of the computer code when the section of the computer code comprises the computer-code vulnerability.

The method may further comprise calculating a function change log index summarizing the function change log. The method may further comprise selecting the fix change log from a plurality of fix change logs based on a similarity of the function change log index and a fix change log index summarizing the fix change log.

According to a further aspect of the disclosure, there is provided a non-transitory computer-readable medium comprising computer instructions stored thereon for detecting vulnerabilities in computer code, wherein the computer instructions, when executed by one or more processors, causes the one or more processors to perform a method comprising: calculating a function change log of a section of the computer code, the function change log comprising at least one intermediate change between a first version of the section of computer code and a second version of the section of computer code, the section of the computer code being similar to a computer-code vulnerability, and the first version is a version prior to the second version. The method further comprises determining whether the section of the computer code comprises the computer-code vulnerability based on a similarity between the function change log and a fix change log, the fix change log comprising at least one code change for fixing the computer-code vulnerability.

The method may further comprise performing any of the operations described above in connection with the first aspect of the disclosure.

According to a further aspect of the disclosure, there is provided a computing device comprising one or more processors operable to perform a method for detecting vulnerabilities in computer code, wherein the method comprises: calculating a function change log of a section of the computer code, the function change log comprising at least one intermediate change between a first version of the section of computer code and a second version of the section of computer code, the section of the computer code being similar to a computer-code vulnerability, and the first version is a version prior to the second version. The method further comprises determining whether the section of the computer code comprises the computer-code vulnerability based on a similarity between the function change log and a fix change log, the fix change log comprising at least one code change for fixing the computer-code vulnerability.

The method may further comprise performing any of the operations described above in connection with the first aspect of the disclosure.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

For a more complete understanding of the disclosure, reference is made to the following description and accompanying drawings, in which:

FIG. 1 is a schematic diagram of a computer network system for detecting vulnerabilities in computer code, according to some embodiments of this disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a schematic diagram of a computer code commit;

FIG. 5 is a schematic diagram of a patch for a vulnerability;

FIG. 6 is a schematic diagram of a patch for a vulnerability;

FIG. 7 is a schematic diagram of a patch for a vulnerability;

FIG. 8 is a flow diagram of a method performed by the computer network system shown in FIG. 1 for detecting vulnerabilities in computer code, according to some embodiments of this disclosure;

FIG. 9 is a schematic diagram of a system for detecting vulnerabilities in computer code, according to some embodiments of this disclosure; and

FIG. 10 is a schematic diagram of a fix change log and a fix change log index.

### DETAILED DESCRIPTION

Embodiments disclosed herein relate to a vulnerability detection module or circuitry for executing a vulnerability detection process.

As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, the vulnerability detection module may be a part of a device, an apparatus, a system, and/or the like, wherein the vulnerability detection module may be coupled to or integrated with other parts of the device, apparatus, or system such that the combination thereof forms the device, apparatus, or system. Alternatively, the vulnerability detection module may be implemented as a standalone device or apparatus.

The vulnerability detection module executes a vulnerability detection process for detecting vulnerabilities in computer code. Herein, a process has a general meaning equivalent to that of a method, and does not necessarily correspond to the concept of computing process (which is the instance of a computer program being executed). More specifically, a process herein is a defined method implemented using hardware components for processing data (for example, computer code, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the vulnerability detection process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The vulnerability detection module may read the computer-executable code from the storage devices and execute the computer-executable code to perform the processes.

Alternatively, the vulnerability detection process disclosed herein may be implemented as one or more hardware structures having necessary electrical and/or optical components, circuits, logic gates, integrated circuit (IC) chips, and/or the like.

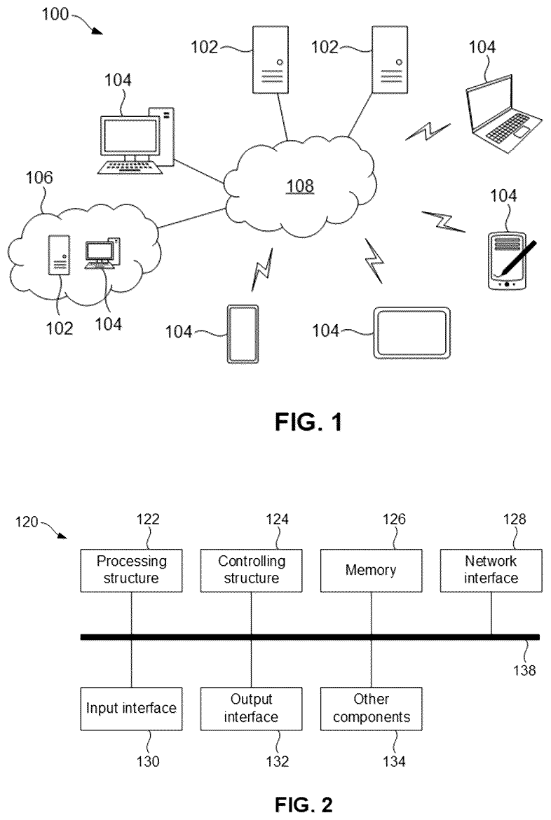

Turning now to FIG. 1, a computer network system for detecting vulnerabilities in computer code is shown and is generally identified using reference numeral 100. In these embodiments, the vulnerability detection system 100 is configured for detecting vulnerabilities in computer code.

As shown in FIG. 1, the vulnerability detection system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections. The client computer systems 106 may have a similar structure as the vulnerability detection system 100.

The server computers 102 may be computing devices designed specifically for use as a server, and/or general-purpose computing devices acting as server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case may be. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 122) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

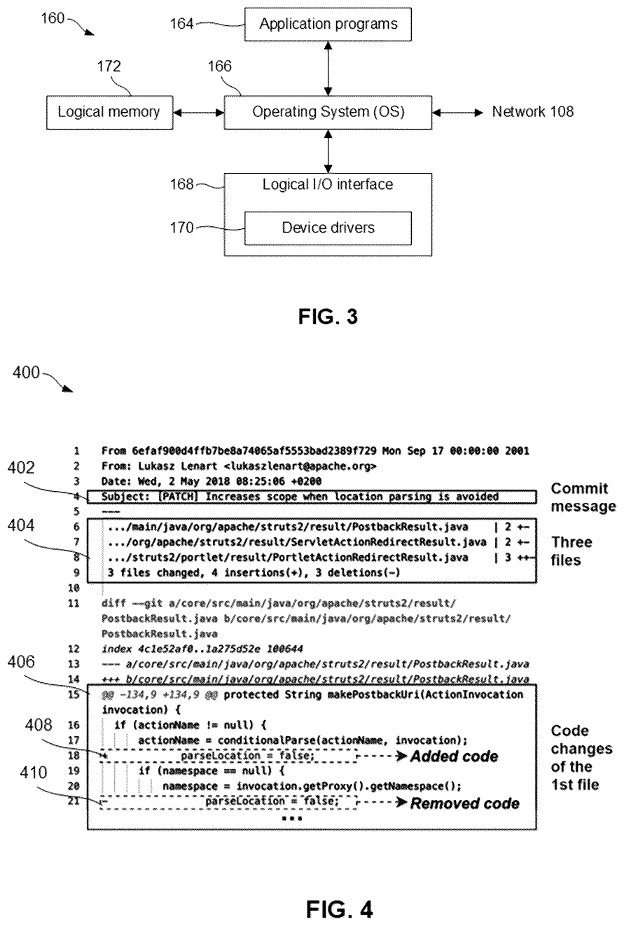

FIG. 3 shows a simplified software architecture 160 of the computing device 102 or 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 of the vulnerability detection system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the vulnerability detection system 100 may have the potential to perform various tasks, it cannot perform any tasks and is of no use without meaningful firmware and/or software. As will be described in more detail later, the vulnerability detection system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

The following embodiments may all be implemented on an electronic device (for example, vulnerability detection system 100) with the foregoing hardware structure.

In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be patched or fixed. Clone-based approaches consider the recurring vulnerability detection problem as a code clone detection problem, such as token- or syntax-based detection. Clone-based approaches may search for computer code sections (also referred to as snippets) in a target computer code repository that are similar to known vulnerabilities. The problem with these clone-based approaches is that they have a high false positive rate. Patches or fixes of vulnerabilities often make small changes to the computer code. As a result, a computer code section containing a vulnerability may be similar to a patched computer code section that does not contain the vulnerability. The differences between a vulnerable code section and a patched code section may be minimal and not detectable by a clone-based approach. Clone-based approaches may detect the patched code section as a vulnerability resulting in false positives.

One example of such clone-based approaches is SourcererCC. As already noted, these approaches have a high false positive rate because they cannot distinguish between vulnerable code sections and patched code sections. These approaches also fail to detect vulnerabilities whose vulnerable code sections have syntactic differences from those of the known vulnerabilities but have the same semantic meaning.

Another approach uses artificial intelligence (AI) to detect vulnerabilities in computer code. One example of such an AI based approach is VulDeePecker. Similar to clone-based approaches, AI based approaches have a high false positive rate because they cannot detect the differences between vulnerable code and patched code. Another problem with these AI based approaches is that they are not programming language agnostic. AI systems trained to detect vulnerabilities will only work with a specific programming language. Each programming language may require its own AI system specifically developed to detect vulnerabilities in that language.

Yet another approach uses function matching. One example of this approach is disclosed in Xiao, Yang, et al. “MVP: Detecting Vulnerabilities using Patch-Enhanced Vulnerability Signatures” USENIX Security Symposium 2020. Such function matching based approaches use an external tool (such as Joern) to generate a signature for the computer code. The signatures may be used to identify computer code sections that are similar to known vulnerabilities. These external tools are unreliable. The method is complex and not generalizable due to delicate and complex signature design. The method is not programming language agnostic. Each programming language may require its own system.

FIG. 4 shows a commit 400 of computer code to a computer code repository. A commit comprises a commit message 402 describing the nature of the change to the computer code, the file names 404 of the files that have been modified, and the changes to the computer code 406. The changes to the computer code 406 show both the added code 408 and the removed code 410. The information contained in a computer code commit 400 in a target repository of computer code may be used to assist in detecting computer code vulnerabilities resulting from the reuse of computer code.

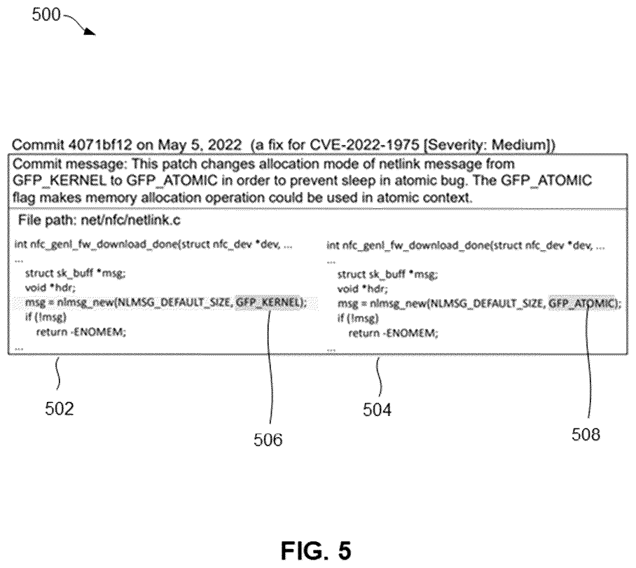

FIG. 5 shows a patch for a vulnerability 500. The first computer code section 502 contains a vulnerability, while the second computer code section 504 has been patched. The vulnerability occurs in a single line of code 506. The fix for the vulnerability comprises a change to a single line of code 508. The only difference between the vulnerable code section 502 and the patched code section 504 is the change of “GFP KERNEL” in line 506 to “GFP ATOMIC” in line 508. The code section 502 and the code section 504 are very similar. As a result, traditional methods for detecting vulnerabilities would likely detect the patched code section 504 as containing the vulnerability even though the vulnerability in code section 504 has been fixed. That is, with traditional methods for detecting vulnerabilities, code section 504 would likely result in a false positive.

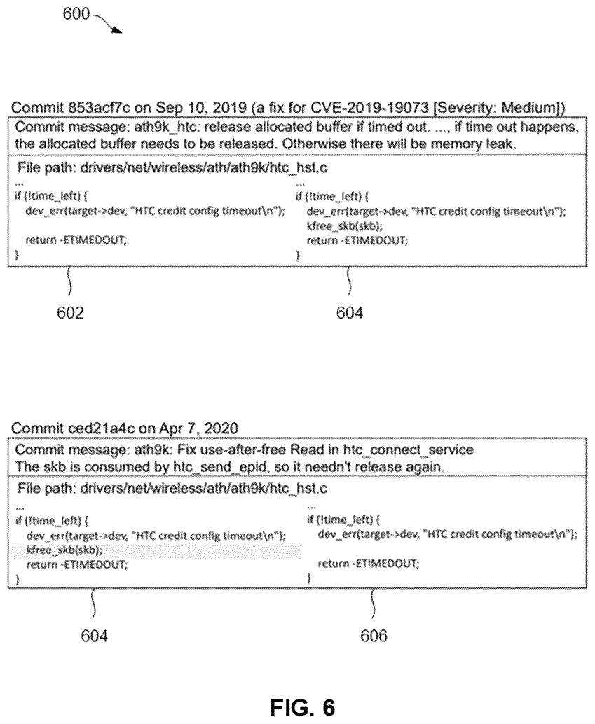

FIG. 6 shows an example of a fix reversion 600. The first computer code section 602 contains a vulnerability, while the second computer code section 604 has been patched. The patch is then reverted in computer code section 606. That is, in computer code section 606, the fix for the vulnerability is removed (the commit is reverted), such that computer code section 606 is identical to the vulnerable computer code section 602. There are many possible reasons why this might be done. For example, the fix in computer code section 604 may be removed because changes to other sections of computer code fix the vulnerability so that the fix in computer code section 604 is no longer needed. Even though computer code section 606 is identical to the vulnerable computer code section 602, it does not contain the vulnerability. Traditional methods for detecting vulnerabilities do not take the historical changes into account. Since the computer code sections 606 and 602 are identical, traditional methods for detecting vulnerabilities would likely detect computer code section 606 as containing the vulnerability even though it has been fixed. With traditional methods for detecting vulnerabilities, code section 606 would likely result in a false positive.

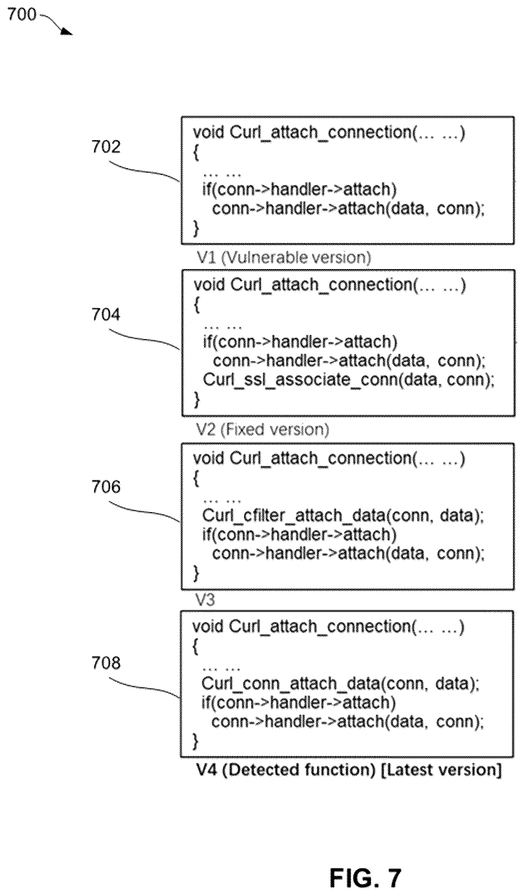

FIG. 7 shows another example of a fix reversion 700. The first computer code section 702 contains a vulnerability, while the second computer code section 704 has been patched. Further changes are made to the computer code section 704 resulting in computer code section 706. Further changes are made to computer code section 706 resulting in computer code section 708. Computer code sections 706 and 708 do not contain the computer code vulnerability. Nonetheless, because they have been modified, they are not similar to the fix for the computer code vulnerability in computer code section 704. Traditional methods for detecting vulnerabilities would likely detect computer code sections 706 and 708 as false positives since they are similar to the vulnerability and are not similar to the patch for the vulnerability. As mentioned above, the historical changes may be taken into account to reduce false positives. For example, computer code section 708 may be compared to each of the computer code sections 702, 704, and 706 by computing a diff or list of changes. If any of the diffs are similar to the fix for the vulnerability, the computer code section 708 may not contain the vulnerability. This method, however, may not work for fix reversions. Since the fix does not appear in computer code section 708, none of the diffs will be similar to the fix for the vulnerability. The intermediate changes in the computer code may need to be taken into account. It may not be sufficient to compare the most recent version with each historical version in the case of fix reversions.

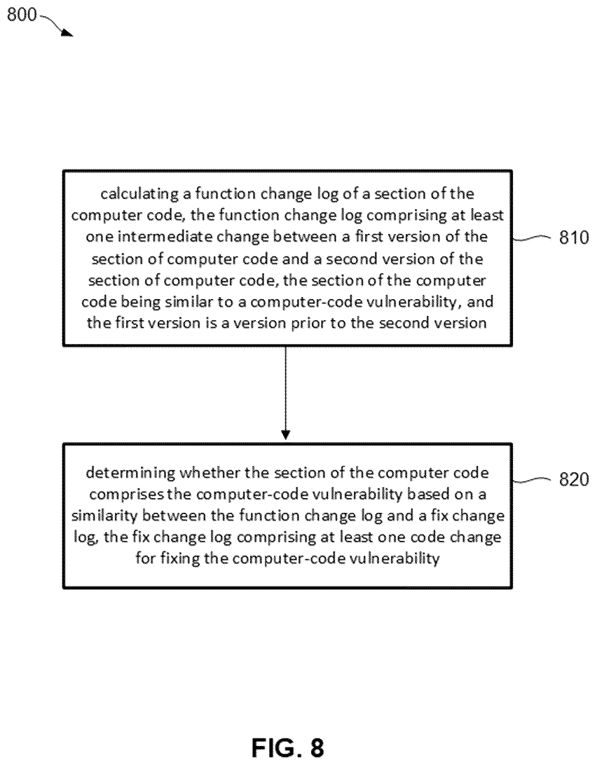

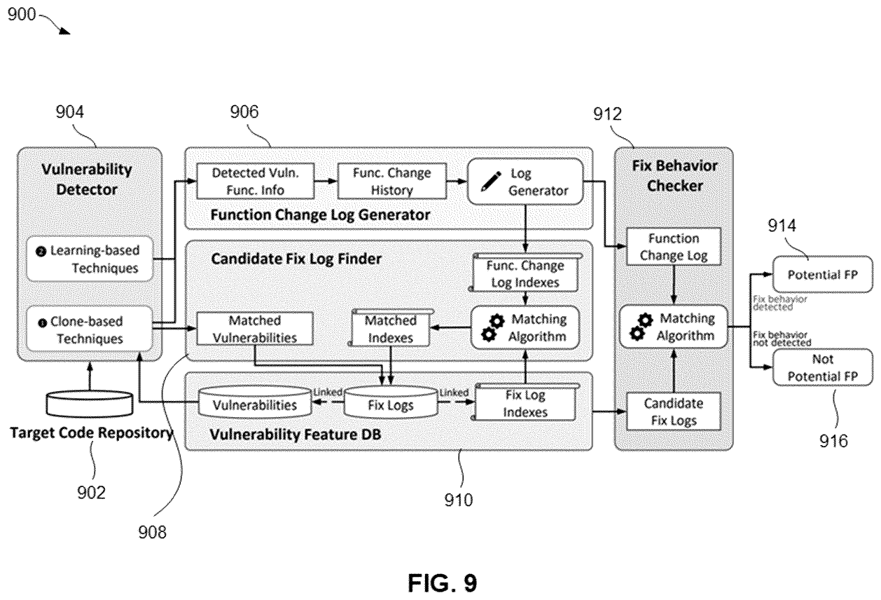

FIG. 8 shows an exemplary method 800 for detecting vulnerabilities in computer code. Computer code may also be referred to as source code. The method 800 may be performed, for example, by the vulnerability detection system 100. The method 800 comprises calculating a function change log of a section of the computer code, the function change log comprising at least one intermediate change between a first version of the section of computer code and a second version of the section of computer code, the section of the computer code being similar to a computer-code vulnerability, and the first version is a version prior to the second version (step 810). FIG. 9 shows a system 900 for detecting vulnerabilities in computer code. The section of computer code may be a section of computer code from a target computer code repository 902, such as Git. The section of computer code may be a function. The section of computer code may be similar to a known vulnerability. The section of computer code may be considered to be similar to the vulnerability if a similarity comparison or measurement between the section of computer code and the vulnerability obtained using a suitable code clone detection method is smaller than a predefined threshold. For example, a code clone detection method may use a text duplication detection method to calculate a similarity score. The section of computer code and the vulnerability are considered similar if the calculated similarity score is smaller than a predefined threshold. The section of computer code potentially contains the vulnerability.

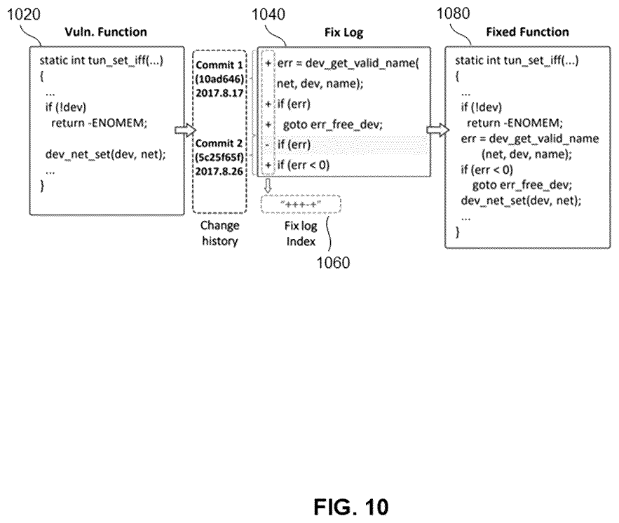

The function change log may be calculated by the function change log generator 906. The change history of the section of computer code may be retrieved from the target computer code repository 902. For example, with Git the command “git log-L::” may be used to retrieve the change history. The function change log generator 906 may retrieve only a subset of all the changes in the change history. For example, the function change log generator 906 may only retrieve the fifty (50) most recent changes to the section of computer code. The function change log generator 906 may concatenate the retrieved changes in chronological order to generate the function change log. Each line in the function change log may be preceded by a “+” or a “−” to indicate whether the change added or removed a line of code, respectively. FIG. 10 shows an example of a fix change log (to be discussed further below). The same process is used to generate a fix change log as a function change log. The fix change log 1040 thus provides an example of a function change log. The function change log may contain intermediate changes between the first version and the second version of the section of computer code. That is, there may exist intermediate versions of the section of computer code between the first version and the second version if the change history contains more than one change. The function change log may contain the changes between the intermediate versions of the section of the computer code. The function change log may contain a complete record of all changes between the first version and the second version of the section of computer code.

The method 800 further comprises determining whether the section of the computer code comprises the computer-code vulnerability based on a similarity between the function change log and a fix change log, the fix change log comprising at least one code change for fixing the computer-code vulnerability (step 820). The objective is to reduce the number of false positives by filtering out the sections of computer code that have already been fixed. A fix change log 1040 of a vulnerability records the line-level code changes from the vulnerable version to the fixed version in chronological order. The fix change log may include some or all of the changes from the first fix to the last fix. Each line in the fix change log 1040 may be preceded by a “+” or a “−” to indicate whether the change added or removed a line of code, respectively. The fix behavior checker 912 may compare the fix change log and the function change log using a matching method to determine if they are similar. If the fix change log is similar to the function change log, then the change history of the section of computer code may comprise the fix for the vulnerability. Even though the section of computer code is similar to the vulnerability, it may not contain the vulnerability because the vulnerability has been patched. The fix behavior checker 912 may then conclude that the section of computer code is a potential false positive 914. If the fix change log is not similar to the function change log, then the fix behavior checker 912 may conclude that the section of computer code is not a potential false positive 916. That is, that it potentially contains the vulnerability. The fix change log may be considered similar to the function change log if it is a subsequence of the function change log. The fix change log may be considered similar to the function change log if a subset of the fix change log is a subsequence of the function change log. The fix change log may be considered a similar to the function change log if they share a number of lines in common above a certain threshold.

The method 800 may further comprise calculating the fix change log. FIG. 10 shows an example of generating a fix change log. The fix change log may be calculated by concatenating each change between the vulnerable code section 1020 and the fixed code section 1080 in chronological order to generate the fix change log 1040. A fix change log of a vulnerability records the line-level code changes from the vulnerable version to the fixed version. If multiple fixes were applied on the same section of code, the last version may be considered as the fully fixed version, and the fix change log records every code change from the first fix to the last fix in chronological order. A single code change may be prefixed by a “+” or “−” symbol, indicating adding a line or removing a line, respectively. The fix change log may be calculated once for each vulnerability and stored for reuse in the vulnerability database 910. Alternatively, the fix change log may be calculated for each section of target computer code that is similar to the vulnerability. Alternatively, the method 800 may retrieve the fix change log from the vulnerability database 910 or from another database.

The method 800 may further comprise locating the section of the computer code that is similar to the computer-code vulnerability. For a given vulnerability, the method 800 may comprise a vulnerability detector 904 that searches for sections of computer code in a target computer code repository 902 that are similar to the known vulnerability. This may be repeated for a plurality of known vulnerabilities. Any suitable method may be used to identify the sections of computer code that are similar to the known vulnerabilities. For example, locating the section of the computer code that is similar to the computer-code vulnerability may comprise using code clone detection. Locating the section of computer code that is similar to the computer-code vulnerability may comprise using artificial intelligence or machine learning. That is, clone-based approaches (such as SourcererCC), artificial intelligence based approaches (such as VulDeePecker), function matching based approaches (such as MVP), or any other suitable approaches may be used to detect vulnerabilities in the target computer code. For a target code repository 902, the vulnerability detector 904 may output the detected vulnerable function information, which consists of the file path, and the function signature. A function signature may comprise parameters and their types, a return value and type. Additionally, for the clone-based detectors, which leverage known vulnerabilities for detection, the matched vulnerabilities may also be provided.

The method 800 may further comprise determining the similarity of the function change log and the fix change log using a matching method. The fix behavior checker 912 may use a matching method to determine whether the function change log and the fix change log are similar. The matching method may determine that the function change log and the fix change log are similar if the fix change log is a subsequence of the function change log. The fix change log may be a subsequence of the function change log if the function change log comprises every line of code from the fix change log in the same order. The following method is an example of such a matching method:

Alg. 1 The Matching Algorithm

| Require: Non-empty Sequence P, Sequence Q | |
|---|---|
| 1: | function SUBSEQUENCEFINDER(P, Q) |
| 2: | i ← 1 |
| 3: | for j ← 1 to length(Q) do |
| 4: | if Pᵢ = Qⱼ then |
| 5: | i ← i + 1 |
| 6: | end if |
| 7: | if i > length(P) then |
| 8: | return true |
| 9: | end if |
| 10: | end for |
| 11: | return false |
| 12: | end function |

The matching method may alternatively use artificial intelligence or machine learning to determine whether the function change log and the fix change log are similar. For example, a neural network may be trained in a supervised or unsupervised manner to determine whether the function change log is similar to the fix change log.

Determining whether the section of the computer code comprises the computer-code vulnerability may comprise determining that the section of the computer code does not comprise the computer-code vulnerability when the function change log is similar to the fix change log. If the function change log for the section of computer code comprises the changes required for the fix (for example, the fix change log is a subsequence of the function change log), then the method 800 may determine that the section of computer code does not contain the vulnerability, since the vulnerability has been patched. The method 800 may determine that the section of computer code is a potential false positive 914. Determining whether the section of the computer code comprises the computer-code vulnerability may comprise determining that the section of the computer code comprises the computer-code vulnerability when the function change log is not similar to the fix change log. If the function change log does not comprise the changes required for the fix (for example, the fix change log is not a subsequence of the function change log), the method 800 may determine that the section of computer code may contain the vulnerability since it has not been patched. The method 800 may determine that the section of computer code is not a potential false positive 916. Since the function change log comprises historical intermediate changes to the section of computer code and does not only compare the most recent version of the section of computer code to historical versions of the section of computer code, the method 800 may detect false positives even when the patch for the vulnerability has been reverted, as in FIG. 7. With regards to the example in FIG. 7, the function change log will comprise the intermediate change “+Curl_ssl_asociate_conn(date,conn);” from version 704. It will also comprise other lines from versions 706 and 708. The fix change log will consist of the line “+Curl_ssl_asociate_conn(date, conn);”, which is the fix for the vulnerability. Therefore, the fix change log will be a subsequence of the function change log, indicating that the section of computer code is a potential false positive. The method 800 may detect false positives even when the section of computer code is identical to the vulnerability when the patch was applied in a past version of the section of computer code.

The method 800 may further comprise receiving the computer-code vulnerability from a security advisory service. The method 800 may receive one or more vulnerabilities and patches from a security advisory service or other database of vulnerabilities. For example, the method 800 may retrieve the one or more vulnerabilities from a remote server 102 via the network 108.

The method 800 may further comprise receiving the computer-code vulnerability and the fix change log from a vulnerability database 910. The system 900 may comprise a vulnerability database 910, which may be a security advisory service. The vulnerability database 910 may store the known vulnerabilities and the fix change logs for those vulnerabilities. Alternatively, the fix change logs may be calculated each time a vulnerability is detected. The system 900 may obtain the vulnerabilities and the fix change logs from the vulnerability database 910 via the network 108. The input to the system 900 may comprise known vulnerabilities from the vulnerability database 910 and target computer code from a repository 902.

The method 800 may further comprise displaying the section of the computer code when the section of the computer code comprises the computer-code vulnerability. If the target computer code contains the vulnerability, the method 800 may comprise reporting this vulnerability to a user.

The method 800 may further comprise calculating a function change log index summarizing the function change log. The method 800 may further comprise selecting the fix change log from a plurality of fix change logs based on a similarity of the function change log index and a fix change log index summarizing the fix change log. The method 800 is compatible with a variety of vulnerability detection techniques. If the vulnerability detector 904 uses a clone-based technique, the vulnerability detector 904 may output the vulnerability that matches the potential vulnerability in the target computer code. The vulnerability database 910 may store the fix change log associated with each vulnerability, such that the system 900 may retrieve the fix change log for the detected vulnerability from the vulnerability database 910. The system 900 may then use the fix change log to determine whether the section of computer code is a false positive as described herein. However, if the vulnerability detector 904 uses an artificial intelligence or machine learning technique to detect vulnerabilities in the target computer code repository 902, the vulnerability detector 904 may not be able to identify the vulnerability. Given the way artificial intelligence and machine learning techniques work, they may be able to detect vulnerabilities without being able to identify which vulnerability the section of computer code resembles. The candidate fix log finder 908 may search through the vulnerability database 910 to identify candidate vulnerabilities and their associated fix change logs. The candidate fix log finder 908 may do this by considering every fix change log in the vulnerability database as a candidate fix change log. The fix behavior checker 912 may then compare the function change log to every fix change log in the vulnerability database 910 to determine if there is a similarity. Given the large number of potential vulnerabilities in the vulnerability database 910, this computation could be time consuming and resource intensive. Alternatively, the candidate fix log finder 908 may attempt to reduce the number of candidate fix change logs. For example, the candidate fix log finder 908 may use fix change log indexes to reduce the number of candidate fix change logs. A fix change log index is a summary of the information contained in the fix change log. Each line-level change in a fix change log may be prefixed by a “+” or “−” symbol, indicating adding a line or removing a line, respectively. The “+” and “−” sequence from a fix change log may be the fix change log index of the corresponding fix change log. That is, a fix change log index may be a sequence of “+” and “−” symbols representing the order of additions and removals in the fix change log. See for example, the fix change log index 1060 for the fix change log 1040 in FIG. 10. The method 800 may further comprise calculating the fix change log index for every fix change log. The vulnerability database 910 may store the fix change log indexes. Function change log indexes may likewise be calculated for function change logs. The candidate fix log finder 908 may select all fix change logs as candidate fix change logs that have fix change log indexes that are similar to the function change log index. For example, all fix change logs may be selected as candidate fix change logs if their fix change log indexes are identical to the function change log index. The fix behavior checker 912 may then have fewer candidate fix change logs to search through to determine whether the section of computer code is a potential false positive. This may increase the speed of processing and improve the efficiency of the system 900.

The method 800 is programming language agnostic. It may be used with any programming language. It may also be used with any vulnerability detection method, such as clone based or artificial intelligence based, to reduce the number of false positives of that vulnerability detection method. The method 800 may be used with any version control system that provides historic commit tracking, such as Git.

The system and method disclosed in the present disclosure may be referred to as Fixed Vulnerability Filter (FVF).

As shown in the table below, FVF improves the performance of clone-based vulnerability detectors:

The performance of clone-based baselines in
detecting similar vulnerabilities across branches
and forks of Linux Kernel and Redis.

| Proj. | | | Original Perf. | | After FVF | | |
|---|---|---|---|---|---|---|---|
| Abbr. | Model | #TP | #FP | FAR | #FP | FAR | IR |
| L.6.3 | Hash-based | 1 | 22 | 95.7% | 2 | 8.7% | 87.0% |
| | Vuddy | 0 | 13 | 100.0% | 2 | 15.4% | 84.6% |
| | ReDeBug | 1 | 89 | 98.9% | 37 | 41.1% | 57.8% |
| L.6.2 | Hash-based | 1 | 28 | 95.8% | 2 | 8.3% | 87.5% |
| | Vuddy | 0 | 13 | 100.0% | 2 | 15.4% | 84.6% |
| | ReDeBug | 1 | 90 | 98.9% | 37 | 40.7% | 58.2% |
| L5.15 | Hash-based | 1 | 28 | 96.6% | 3 | 10.3% | 86.2% |
| | Vuddy | 0 | 16 | 100.0% | 3 | 18.8% | 81.3% |
| | ReDeBug | 1 | 92 | 98.9% | 39 | 41.9% | 57.0% |
| L.A | Hash-based | 1 | 26 | 96.3% | 2 | 7.4% | 88.9% |
| | Vuddy | 0 | 15 | 100.0% | 2 | 13.3% | 86.7% |
| | ReDeBug | 1 | 91 | 98.9% | 37 | 40.2% | 58.7% |
| L.L | Hash-based | 22 | 26 | 54.2% | 2 | 4.2% | 50.0% |
| | Vuddy | 3 | 16 | 84.2% | 2 | 10.5% | 73.7% |
| | ReDeBug | 19 | 94 | 83.2% | 39 | 34.5% | 48.7% |
| L.O | Hash-based | 1 | 28 | 96.6% | 3 | 10.3% | 86.2% |
| | Vuddy | 0 | 16 | 100.0% | 3 | 18.8% | 81.3% |
| | ReDeBug | 1 | 111 | 99.1% | 42 | 37.5% | 61.6% |
| R.7 | Hash-based | 0 | 5 | 100.0% | 0 | 0.0% | 100.0% |
| | Vuddy | 0 | 3 | 100.0% | 0 | 0.0% | 100.0% |
| | ReDeBug | 0 | 5 | 100.0% | 0 | 0.0% | 100.0% |
| R.5 | Hash-based | 7 | 3 | 30.0% | 0 | 0.0% | 30.0% |
| | Vaddy | 2 | 2 | 50.0% | 0 | 0.0% | 50.0% |
| | ReDeBug | 8 | 3 | 27.3% | 0 | 0.0% | 27.3% |
| R.B | Hash-based | 7 | 3 | 30.0% | 0 | 0.0% | 30.0% |
| | Vuddy | 2 | 2 | 50.0% | 0 | 0.0% | 50.0% |
| | ReDeBug | 8 | 3 | 27.3% | 0 | 0.0% | 27.3% |
| Total | — | 34 | 133 | 79.6% | 48 | 28.7% | 50.9% |

(#FP: #False positive, FAR: False alarm rate.)

As shown in the table below. FVF improves the performance of artificial intelligence and machine learning based vulnerability detectors:

Performance of learning-based baseline.

| | | | | On TPs | | | | |
|---|---|---|---|---|---|---|---|---|
| | On Test data | | | (Latest fixed ver.) | | After FVF | | |
| Model | #FP | FAR | #TP | #FP | FAR | #FP | FAR | IR |
| LineVul | 1 | 8.33% | 241 | 240 | 99.59% | 22 | 9.13% | 90.8% |
| V-CNN | 352 | 28.23% | 321 | 234 | 72.90% | 29 | 9.03% | 87.6% |
| V-MLP | 303 | 24.30% | 311 | 240 | 77.17% | 30 | 9.65% | 87.5% |

(#FP: #False positive, FAR: False alarm rate.)

As shown below, FVF improves the performance of ChatGPT:

Performance of ChatGPT.

| | On TPs (Latest fixed ver.) | | After FVF | | |
|---|---|---|---|---|---|
| Settings | #FP | FAR | #FP | FAR | IR |
| Vuln. + Fixed | 361 | 58.89% | 61 | 7.93% | 83.6% |
| Only Fixed | 199 | 31.29% | 33 | 6.13% | 86.5% |

Although embodiments have been described above with reference to the accompanying drawings, those of skill in the art will appreciate that variations and modifications may be made without departing from the scope thereof as defined by the appended claims.

1. A method for detecting vulnerabilities in computer code, comprising:
calculating a function change log of a section of the computer code, the function change log comprising at least one intermediate change between a first version of the section of computer code and a second version of the section of computer code, the section of the computer code being similar to a computer-code vulnerability, and the first version being a version prior to the second version; and
determining whether the section of the computer code comprises the computer-code vulnerability based on a similarity between the function change log and a fix change log, the fix change log comprising at least one code change for fixing the computer-code vulnerability.

2. The method of claim 1 further comprising:
calculating the fix change log, or receiving the fix change log from a vulnerability database.

3. The method of claim 1 further comprising:
locating the section of the computer code that is similar to the computer-code vulnerability using code clone detection or artificial intelligence.

4. The method of claim 1 further comprising:
determining the similarity of the function change log and the fix change log using a matching method;
wherein the matching method comprises:
determining whether the fix change log is a subsequence of the function change log, or
using artificial intelligence to determine the similarity of the function change log and the fix change log.

5. The method of claim 1, wherein said determining whether the section of the computer code comprises the computer-code vulnerability comprises:
determining that the section of the computer code does not comprise the computer-code vulnerability when the function change log is similar to the fix change log; or
determining that the section of the computer code comprises the computer-code vulnerability when the function change log is not similar to the fix change log.

6. The method of claim 1 further comprising:
calculating a function change log index summarizing the function change log; and
selecting the fix change log from a plurality of fix change logs based on a similarity of the function change log index and a fix change log index summarizing the fix change log.

7. A non-transitory computer-readable medium comprising computer instructions stored thereon for detecting vulnerabilities in computer code, wherein the computer instructions, when executed by one or more processors, causes the one or more processors to perform a method comprising:
calculating a function change log of a section of the computer code, the function change log comprising at least one intermediate change between a first version of the section of computer code and a second version of the section of computer code, the section of the computer code being similar to a computer-code vulnerability, and the first version is a version prior to the second version; and
determining whether the section of the computer code comprises the computer-code vulnerability based on a similarity between the function change log and a fix change log, the fix change log comprising at least one code change for fixing the computer-code vulnerability.

8. The non-transitory computer-readable medium of claim 7, wherein the method further comprises:
calculating the fix change log, or receiving the fix change log from a vulnerability database.

9. The non-transitory computer-readable medium of claim 7, wherein the method further comprises:
locating the section of the computer code that is similar to the computer-code vulnerability.

10. The non-transitory computer-readable medium of claim 9, wherein said locating the section of the computer code that is similar to the computer-code vulnerability comprises:
locating the section of the computer code that is similar to the computer-code vulnerability using code clone detection or artificial intelligence.

11. The non-transitory computer-readable medium of claim 7, wherein the method further comprises:
determining the similarity of the function change log and the fix change log using a matching method.

12. The non-transitory computer-readable medium of claim 11, wherein the matching method comprises:
determining whether the fix change log is a subsequence of the function change log, or
using artificial intelligence to determine the similarity of the function change log and the fix change log.

13. The non-transitory computer-readable medium of claim 7, wherein said determining whether the section of the computer code comprises the computer-code vulnerability comprises:
determining that the section of the computer code does not comprise the computer-code vulnerability when the function change log is similar to the fix change log; or
determining that the section of the computer code comprises the computer-code vulnerability when the function change log is not similar to the fix change log.

14. The non-transitory computer-readable medium of claim 7, wherein the method further comprises:
calculating a function change log index summarizing the function change log; and
selecting the fix change log from a plurality of fix change logs based on a similarity of the function change log index and a fix change log index summarizing the fix change log.

15. A computing device comprising one or more processors operable to perform a method for detecting vulnerabilities in computer code, wherein the method comprises:
calculating a function change log of a section of the computer code, the function change log comprising at least one intermediate change between a first version of the section of computer code and a second version of the section of computer code, the section of the computer code being similar to a computer-code vulnerability, and the first version is a version prior to the second version; and
determining whether the section of the computer code comprises the computer-code vulnerability based on a similarity between the function change log and a fix change log, the fix change log comprising at least one code change for fixing the computer-code vulnerability.

16. The computing device of claim 15, wherein the method further comprises:
calculating the fix change log, or receiving the fix change log from a vulnerability database.

17. The computing device of claim 15, wherein the method further comprises:
locating the section of the computer code that is similar to the computer-code vulnerability using code clone detection or artificial intelligence.

18. The computing device of claim 15, wherein the method further comprises:
determining the similarity of the function change log and the fix change log using a matching method;
wherein the matching method comprises:
determining whether the fix change log is a subsequence of the function change log, or
using artificial intelligence to determine the similarity of the function change log and the fix change log.

19. The computing device of claim 15, wherein said determining whether the section of the computer code comprises the computer-code vulnerability comprises:
determining that the section of the computer code does not comprise the computer-code vulnerability when the function change log is similar to the fix change log; or
determining that the section of the computer code comprises the computer-code vulnerability when the function change log is not similar to the fix change log.

20. The computing device of claim 15, wherein the method further comprises:
calculating a function change log index summarizing the function change log; and
selecting the fix change log from a plurality of fix change logs based on a similarity of the function change log index and a fix change log index summarizing the fix change log.
